(19) United States
(12) Patent Application Publication
(10) Pub. No.: US 2012/0219932 A1
(43) Pub. Date: Aug. 30, 2012

(54) SYSTEM AND METHOD FOR AUTOMATED SPEECH INSTRUCTION

(76) Inventors: Eyal ESHED, Bnei Atarot (IL); Ariel Velikovsky, Modi'in (IL); Sherrie Ellen Shammass, Gedera (IL)

(21) Appl. No.: 13/405,421

(22) Filed: Feb. 27, 2012

Related U.S. Application Data
(60) Provisional application No. 61/447,056, filed on Feb. 27, 2011.

(51) Int. Cl. G09B 19/04

(52) U.S. Cl. 434/185

(57) ABSTRACT

A system and method of speech instruction including generating computer audible speech from any text that is to be spoken by a human speaker, recording the human speech of the text data that was repeated by the human speaker based on the computer generated speech, evaluating the human speech by an automated speech recognition engine to determine a quality of the human speech, and providing feedback to the speaker.

### CROSS REFERENCE TO RELATED APPLICATIONS

This application claims the benefit of U.S. Provisional Application No. 61/447,056, filed on Feb. 27, 2011, entitled Automatic System and Method for Presentation Training, incorporated by reference in its entirety herein.

### FIELD OF THE INVENTION

This application relates to automated instruction in oratory arts the speaking arts, and in particular to providing computer generated speech, and to evaluating human speech.

### BACKGROUND OF THE INVENTION

Systems are available that allow computer or automated generation of speech from a known or given text. Systems are also available for allowing a computer to identify spoken words and transcribe, interpret or otherwise evaluate a quality of such identified spoken words.

Many people seek assistance in improving the quality of their speech for professional needs such as business presentations, lecturing, taking interviews, or acting Speech therapists, oratory coaches, accent modifiers and other such professionals focus on training and evaluating spoken words to improve diction, pronunciation, understandability or other characteristics or qualities of a speaker's words. Such assistance, whether professional or lay, relies on individualized lessons or training that may be time consuming and expensive. This invention provides a system for customized speech training without a human intervening in any of the training modules.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a system including a sound reproduction device, a sound input device, a processor, a memory and a display in accordance with an embodiment of the invention;

FIG. 2 is a flow diagram of a method in accordance with an embodiment of the invention; and

FIG. 3 is a flow diagram of a method of instruction for improving a quality of human speech in accordance with an embodiment of the invention.

### DETAILED DESCRIPTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored as instructions on an article such as a memory device, where such instructions upon execution by a processor result in a method of an embodiment of the invention.

As used in this application, the term ‘free text’ may, in addition to its regular meaning, including text that includes a range of vocabulary, sentence complexity, oratory flow and variability as may be included in a speech that be delivered to an audience or that may be used in free flowing conversation. Free text may exceed the limited range of words, questions, sentences and narrow sentence structure that may be enabled in for example an automated customer service system that relies on a limited number of questions and possible responses to such questions. Free text may include text that may be formulated and revised immediately or in real time prior to its being input into a text to speech system. In some embodiments, free text may include text data such as words or letters that form phrases or sentences that is stored in electronic form such as in ASCI. Free text may include textual content from any source, including presentations, slides, printed material, internet content, scripts, and self-authored material.

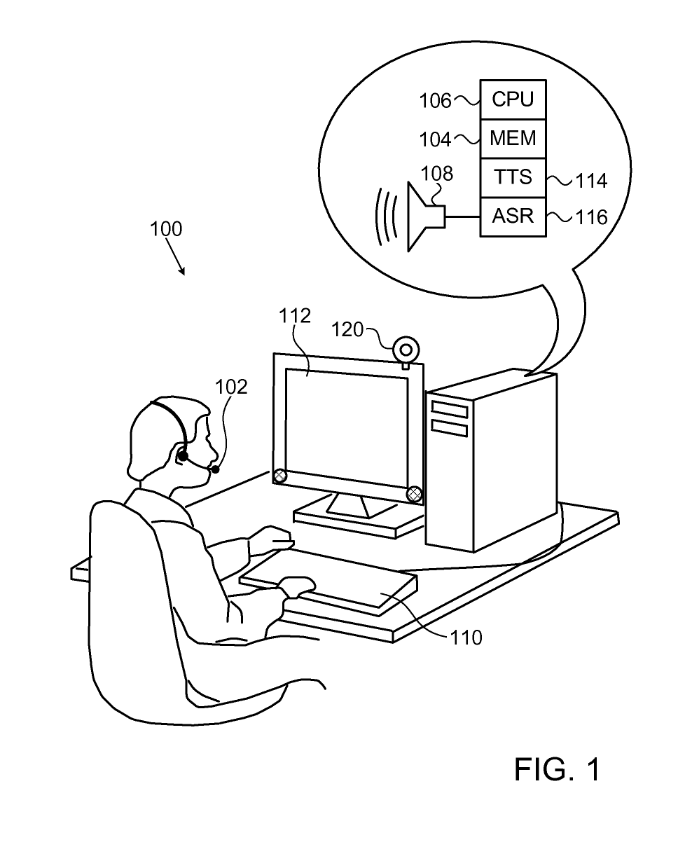

Reference is made to FIG. 1, a schematic diagram of a system including a sound reproduction device, a sound input device, a processor, a memory and a display in accordance with an embodiment of the invention. System 100 may include a sound input device such as a microphone 102 or other voice recording mechanism, one or more mass data storage modules such as a memory 104, a processor 106 such as a central processing unit that may be associated with memory 104, a sound generation or reproduction unit such as headphones or a loudspeaker 108, a data input device such as a keyboard 110, a display device such as a monitor or screen 112 and an imager 120. Various software packages or modules may be stored on memory 104 and such packages or modules may be executed by one or more processors 106 to carry out embodiments of the present invention.

Embodiments of the invention may allow self-authoring of material for use in customized self-learning speech training sessions.

In some embodiments, a software package may include an automated text to speech (TTS) 114 engine that when executed by a processor may include text (e.g., free text) as an input and may generate audible speech based on such text for example outing via or by way of loudspeaker 108. Text may be input into or received by the TTS for example as digitized text data that may have been stored in memory 104, or text data that may have been input from for example a written text that may be scanned or optically identified as particular words for which automated or computer generated speech may be created. In some embodiments, a recording or recordings of words or phrases spoken by a person may be stored in memory 104, and processor 106 may identify words in a stored text and assemble the recorded words to generate speech that matches or corresponds to the text (e.g., simulates a person reading the text or acting the text or orating the text or using the text in a presentation or lecture). Computer generated speech may therefore include either or both speech recorded from a human speaker, and speech generated by from sounds created by a computer. TTS 114 packages that may be suitable for use in embodiments of the invention may include those available from Loquendo, Nuance and Ivona. Other ways of generating voice are possible.

In some embodiments, a software package executed as part of an embodiment of the invention (e.g., by processor 106) may include an automated speech recognition (ASR) 116 engine package that may identify spoken words or utterances. ASRs may also evaluate various qualities of spoken words such as diction, accent, dialect, understandability, speed, emotion, as well as the severity and frequency of various speech or pronunciation problems. ASR packages that may be suitable for use in embodiments of the invention may include those available from for example SRI International, CMU Robust Speech Recognition, and Nuance.

In operation, a text may be input into or received by a TTS 114 and a processor may generate audible speech based on the inputted or received text. A person may hear the computer generated speech and may repeat the words that he heard or some other words based on such words or similar to such words. The speech produced by the person may be based on or correspond to the text, as if the person had read the text. The person may vocalize the speech in a manner normal for that person, or in some cases in a manner different from normal for that person. For example, the person may try to emulate the computer generated speech, vocalizing to produce speech different from that produced if the person had read the original inputted text on which the computer-output speech is based, but based on or corresponding to the original inputted text. The speaker's words may be input into ASR 116, which may identify the words and evaluate one or more qualities of the identified words, syllables or other human spoken sounds from the person repeating the speech on the basis of one or more qualities of such spoken words. In some embodiments such qualities may include diction, pronunciation, voice modulation, pitch, tone, emphasis, emotion speed or rate of speech, stammering, accent, dialect, or other characteristics of a speaker's speech. ASR 116 may present to a user feedback such as one or more comments, criticisms or evaluations of a quality of the identified, recorded or spoken words. Such feedback, comments or evaluations may be presented by way of for example loudspeaker 108, screen 112 or by another device. In some embodiments, the user chooses specific parameters available from the TTS 114 and ASR 116 components to customize a speaking lesson for specific purposes. For example, a user may desire to be able to speak in a political foray. The user may configure a system to deliver assessments and examples so that the user may obtain speaking patterns that represent a particular standard dialect with a lower pitch for signaling authority, and a slower delivery rate for intelligibility. In an embodiment, a salesperson training a sales pitch may desire to sound less formal, more fluent and with a faster speech rate in order to fit in the sales pitch within a short pre-determined time limitation.

In some embodiments, ASR 116 may identify the spoken words and signal TTS to repeat the inputted text and generated speech as a way of getting a speaker to repeat and improve a desired quality of his speech. ASR 116 may detect levels of ability and areas that need additional repetition and instruction. One or a series of texts may be converted from texts stored in a memory and used for lessons that reflect the abilities and progress of the speaker.

In some embodiments, an input to TTS 114 may include for example a prepared speech or slides of a prepared speech or presentation. TTS 114 may produce or generate speech that is based on text included in the slides or the prepared speech, and the person may listen to the generated speech and repeat some or all of the words, phrases or text that is included in the speech. TTS 114 may be configured by to desired speech traits that the person would like to attain. For example, if the person would like to present a lecture in a more modulated tone so that it will not sound boring, parameters of the TTS 114 may be chosen to output relevant samples. Parameters may also be preset within the system so that TTS 114 output conforms to specific templates of speech delivery (for example, for better business presentations). ASR 116 may detect and identify the speech and evaluate one or more properties of the person's speech. ASR 116 may evaluate the person's speech, and present comments or an indication of which parts of the speech should be improved. For example, ASR 116 may detect that a speaker speaks too quickly, or speaks with too high of a pitch or mispronounces certain words. ASR 116 may issue or transmit a signal or report on for example screen 112 to indicate to a speaker the part of the speech delivery that should be improved. ASR 116 or another program may signal TTS 114 to repeat a particular phrase or word in the speech and may provide a comment on a factor or quality that needs to be improved. ASR may also record a signal in for example a text of the speech that may indicate to a reader a particular passage of the speech that the speaker needs to improve and may highlight or otherwise indicate the type of improvement that the speaker may focus on to make such improvement.

In some embodiments, ASR 116 may evaluate for example a modulation, pitch, tone, emphasis or emotion of a speaker's voice and may provide feedback to the speaker on one or more of such factors. In some embodiments, a camera or video recorder may capture one more images of the speaker while the speaker is repeating a phrase or sentence, and the comments generated upon an evaluation by ASR 116 may accompany a display of the speaker as he was saying the relevant words or phrase. In some embodiments, a user or speaker may edit a text of a speech or presentation to adjust for words, phrases or sentences that ASR 116 indicates are not understandable or otherwise not intelligible.

In some embodiments, TTS 114 may be adjustable to provide sentence by sentence generated speech so that a user can practice and receive evaluation or comments on each section of a speech. Other settings such as slide by slide, word by word or other combinations may also be used.

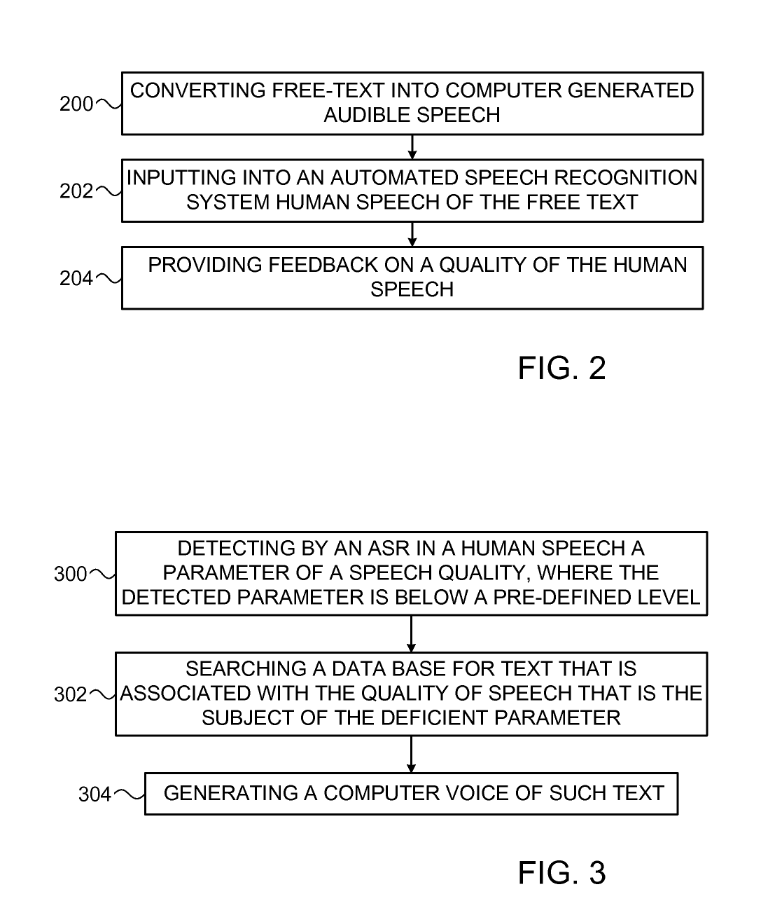

Reference is made to FIG. 2, a flow diagram of a method in accordance with an embodiment of the invention. In some embodiments, a method of speech training may include as in block 200, converting text such as free-text into computer and generating audible speech of the free-text. Such free text may be input into a TTS engine as electronic text data or may for example be inputted into a TTS engine from optical character recognition of a printed text. In reaction to hearing the computer generated audible speech, a user may repeat the computer generated audible speech by speaking. The user's speech may correspond to the audible speech, or repeat the text. In block 202, human speech corresponding to the free text may be inputted or received by way of for example a microphone into an automated speech recognition system. For example, the user's speech may be captured by a microphone. In block 204, feedback on a quality of the human speech that repeats the computer generated speech may be formulated by for example an ASR engine and may be provided to for example the speaker of the human speech.

In some embodiments, the free-text may be converted from text stored in digital format or any other type of format such as printed material, Powerpoint™ presentations, subtitles.

In some embodiments, converting the free-text into audible speech may include converting into computer generated speech in a dialect that matches a dialect of speaker of the human speech or a dialect that the speaker would like to emulate.

In some embodiments, providing feedback from an evaluation of the human speech may include providing such feedback immediately or substantially immediately after the human speech in input into an ASR engine.

In some embodiments, providing feedback from an evaluation of the human speech includes providing feedback on one or more qualities or characteristics of the human speech such as for example diction, intonation, accent, speed, intelligibility, emotion and pauses.

Some embodiments may include generating audible speech by a computer if an automated speech recognition system identifies that a word, phrase or sentence that was included in a human speech matches a word, phrase or sentence that is stored in a memory. In case the spoken word, phrase or sentence is evaluated as needing improvement, the TTS may generate speech of the identified human speech and generate computer speech of such text that is to be repeated by the human speaker.

In some embodiments, a method may include presenting a display of the free-text and adding comments, visible marks or indications of an evaluation of a relevant portion of the human speech on an area of the display that includes the free-text spoken in the human speech.

In some embodiments, the free-text may be repeated by the TTS if the quality of the human speech of the free-text is below a pre-defined level or threshold.

In some embodiments, the human speech may repeat the text of the free-text data that was generated by the TTS. In some embodiments, a signal may be generated by an ASR with a result of an evaluation of the human speech as compared to the speech of the TTS.

Some embodiments may present a display of a portion of the free-text data along with an evaluation of the quality of the human speech of such portion.

In some embodiments, a signal from the automated speech recognition engine may include a recommendation for an improvement of the human speech.

Reference is made to FIG. 3, a flow diagram of a method of instruction for improving a quality of human speech in accordance with an embodiment of the invention. In some embodiments, a method of the invention may include as in block 300, inputting into an ASR a human speech and detecting in such a human speech a parameter of a speech quality, where the detected parameter is below a pre-defined level. For example, a speaker may recite or read a sentence or paragraph into an ASR. The ASR may detect that the speaker has not enunciated certain words with sufficient clarity or intelligibility If the parameter is below a pre-defined level correction may be provided, and if not, no correction may be provided. For example, in block 302, a search may be performed of for example a data base of words, phrases or sentences that include are associated with the quality of speech that is the subject of the deficient parameter. In block 304, a computer may generate audible words or phrases and instruct the speaker to say the generated words as part of an exercise to improve the quality of the speaker's speech. In some embodiments, a presentation to the speaker may be accompanied by one or more images or videos on how to say the words or how to improve a particular sound. For example such a presentation may include an exercise for movement of the tongue, lips or other parts to improve the speaker's clarity.

Some embodiments of the invention may be implemented, for example, using an article including or being a non-transitory machine-readable or computer-readable storage medium, having stored thereon instructions, that when executed on a computer, cause the computer to perform method and/or operations in accordance with embodiments of the invention. The computer-readable storage medium may store an instruction or a set of instructions that, when executed by a machine (for example, by a computer, a mobile device and/or by other suitable machines), cause the machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method for fully automated speech training, comprising:
converting free-text into computer generated audible speech;
receiving at a system human speech corresponding to said free text; and
providing from said system, feedback on a quality of said human speech.

2. The method as in claim 1, wherein said converting comprises converting free-text stored in digital format.

3. The method as in claim 1, wherein said converting comprises converting said free-text into audible speech in a dialect that matches a dialect of the speaker of said human speech.

4. The method as in claim 1, wherein said providing feedback comprises providing feedback immediately after said inputting of said human speech.

5. The method as in claim 1, wherein said providing feedback comprises providing feedback on a quality of said human speech, said characteristics selected from the group comprising diction, intonation, accent, speed, intelligibility, and pauses.

6. The method as in claim 1, comprising repeating said generated audible speech of said free-text upon a signal from said automated speech recognition system that said human speech of said free-text did not satisfy a pre-defined criteria.

7. The method as in claim 1, wherein said converting free-text into computer generated audible speech comprises converting free-text into computer generated speech upon a signal from said automated speech recognition that said human speech includes said free-text.

8. The method as in claim 1, comprising adding to a display of said free-text a visible mark reflecting said feedback.

9. The method as in claim 1, comprising repeating said computer generated audible speech if said quality of said human speech of said free-text is below a pre-defined level.

10. A system comprising:
a memory; and
a processor, said processor to:
generate audible speech from free-text data;
evaluate a quality of inputted human speech, said human speech repeating a text corresponding to the free-text data; and
issue a signal, said signal including a result of said evaluation.

11. The system as in claim 10, including a display to present an indication of a portion of said free-text data and an evaluation of said quality of said human speech about said portion.

12. The system as in claim 10, wherein said generating comprises generating said audible speech in a dialect matching a dialect of a speaker of said human speech.

13. The system as in claim 10, wherein said signal includes a recommendation for an improvement of said human speech.

14. The system as in claim 13, wherein said signal includes an evaluation of a characteristic of said human speech, said characteristic selected from the group comprising diction, intonation, accent, speed, intelligibility, and pauses.

15. The system as in claim 10, wherein said processor is to repeat said generated audible speech of said free-text if said evaluation does not satisfy a pre-defined criteria.

16. The system as in claim 10, comprising a display to present said free-text with an indication of said evaluation of said human speech corresponding to said free-text.

17. A method of speech instruction, comprising:
detecting in human speech a parameter of a speech quality, said parameter below a pre-defined level;
identifying stored text data associated with an exercise to improve said quality; and
generating an audible speech from a computer of said stored text data.

18. The method as in claim 17, said method comprising presenting to a speaker of said human speech an instruction to speak said text data.

19. The method as in claim 17, comprising presenting to a speaker of said human speech, an image of an exercise to improve said quality.
